(19) United States
(12) Patent Application Publication
(10) Pub. No.: US 2013/0236862 A1
(43) Pub. Date: Sep. 12, 2013

(54) APPARATUS FOR DISPLAYING GENEALOGY INFORMATION

(71) Applicant: John P. Dilworth, Ogden, UT (US)

(72) Inventor: John P. Dilworth, Ogden, UT (US)

(21) Appl. No.: 13/603,397

(22) Filed: Sep. 4, 2012

Related U.S. Application Data
(60) Provisional application No. 61/530,818, filed on Sep. 2, 2011.

(51) Int. Cl. G09B 19/00

(52) U.S. Cl. CPC G09B 19/0046
USPC 434/154

(57) ABSTRACT

An apparatus and system are disclosed for displaying genealogy information. The apparatus includes a container. One or more first generation pieces fit together to form a first layer in the container. At least one first generation piece includes identity information of a person (“first generation person”). Each first generation person is related to a person (“original person”) through a genealogical relationship. One or more second generation pieces fit together to form a second layer in the container. At least one second generation piece includes identity information of a person (“second generation person”). Each second generation person is related to a first generation person identified on at least one of the first generation pieces through a genealogical relationship.

### CROSS-REFERENCES TO RELATED APPLICATIONS

This application claims the benefit of U.S. Provisional Patent Application No. 61/530,818 entitled “APPARATUS FOR DISPLAYING GENEALOGY INFORMATION” and filed on Sep. 2, 2011 for John P. Dilworth, which is incorporated herein by reference.

### FIELD OF THE INVENTION

This invention relates to genealogy and more particularly relates to displaying genealogical information in layers within a container.

### BACKGROUND

### Description Of The Related Art

Family history is of interest to a very wide audience and is highly personal and valuable, but there are limited ways to effectively display and share this information with others. Keeping a record of one's family history is most often accomplished on paper with the use of pedigree charts, drawings of trees, or more recently on a computer, stored in a digital data file.

Typical genealogical information is displayed in a four generation sheet, family bible, some type of pedigree chart, etc. While it is common to display genealogical information for purposes of genealogical research, very few methods exist to display genealogical information in a manner that can be displayed to family and friends. Paper related genealogical records do not have inherent value, and are not conducive to regular and frequent display. Additionally, paper products are less likely to be archived, and passed along as a family heirloom.

One common way to make a display of genealogical information is a pedigree chart in the form of a picture or wall hanging. Wall art and painted family trees are typically framed and placed on a wall, but cannot be interacted with.

While this display is appropriate for some occasions, there exists a need to display genealogical information in a way that is appropriate as a gift to be passed on as a family heirloom. In addition, there exists a need for a genealogical display that can be a game.

### SUMMARY

From the foregoing discussion, it should be apparent that a need exists for an apparatus that displays genealogical information in the form of a container with pieces that form layers within the container. Each layer includes identity information of people within a family relationship. Beneficially, such an apparatus would provide a way of displaying genealogical information of a family in a way that is fun, interesting, and can be passed on as a family heirloom.

The present invention has been developed in response to the present state of the art, and in particular, in response to the problems and needs in the art that have not yet been fully solved by currently available methods or products for displaying family history or genealogical information. Accordingly, the present invention has been developed to provide an apparatus and system for displaying genealogy information that overcome many or all of the above-discussed shortcomings in the art.

An apparatus of the present invention is presented for displaying genealogy information. In one embodiment, the apparatus includes a container. In another embodiment, the apparatus includes one or more first generation pieces that fit together to form a first layer in the container. In an additional embodiment, at least one first generation piece includes identity information of a person (“first generation person”). In a further embodiment, each first generation person is related to a person (“original person”) through a genealogical relationship. In another embodiment, the apparatus includes one or more second generation pieces that fit together to form a second layer in the container. In a further embodiment, at least one second generation piece includes identity information of a person (“second generation person”). In an additional embodiment, each second generation person is related to a first generation person identified on at least one of the first generation pieces through a genealogical relationship.

In one embodiment, the apparatus includes one or more additional generation pieces forming one or more additional layers. In a further embodiment, at least one additional piece includes identity information of a person. In another embodiment, each person on an additional piece is related to another person identified on another layer.

In one embodiment, the original person includes a child. In an additional embodiment, each first generation person includes a parent of the child, and each second generation person includes a grandparent of the child.

In one embodiment, the apparatus includes one or more third generation pieces that fit together to form a third layer in the container. In a further embodiment, at least one third generation piece includes identity information of a great grandparent of the child.

In one embodiment, the pieces within a layer fit such that the pieces substantially fill a layer within the container. In another embodiment, the pieces within a layer interlock.

In one embodiment, the container includes a box and each layer includes pieces that fit together to form a layer and to substantially fill a space including the layer. In a further embodiment, the pieces within a layer include shapes other than rectangles and are shaped to fit together in a particular order.

In one embodiment, the identity information of a person includes a name, a birth date, a christening date, a baptismal date, a marriage date, a death date, and/or a familial relationship status. In another embodiment, each piece includes an identifier that includes information regarding order of the piece within the container.

In one embodiment, the container includes a square shape, a rectangular shape, a cylindrical shape, an organic shape, and/or a round shape. In a further embodiment, the pieces within a layer include at least one piece with identity information of a person related through a relationship other than a biological relationship.

In one embodiment, the container includes a lid. In another embodiment, container includes information on the exterior of the case relating to the original person.

In one embodiment, the identity information is engraved into a piece. In another embodiment, the identity information is burned into a piece. In a further embodiment, the identity information is printed on a piece. In an additional embodiment, the identity information is attached to a piece with an adhesive.

In one embodiment, the apparatus includes one or more base generation pieces that fit together to form a base layer in the container. In another embodiment, at least one base generation piece includes identity information of the original person. In a further embodiment, each piece in the base layer includes identity information of a person related to a first generation person through a genealogical relationship.

In one embodiment, the container is a first container and includes a second container and a super container. In an additional embodiment, the second container includes pieces related to a spouse or a partner of the original person. In another embodiment, the first and second containers fit within the super container.

In one embodiment, one or more pieces within a layer fit substantially within a footprint of a piece in an adjacent layer. In an additional embodiment, identity information of the pieces within the layer is for people genealogically related to the person identified by the identity information on the piece in the adjacent layer.

An apparatus of the present invention is presented for displaying genealogy information. In one embodiment, the apparatus includes a container. In a further embodiment, the apparatus includes two first generation pieces that fit together to form a first layer in the container. In another embodiment, at least one first generation piece includes identity information of a parent related to a child. In an additional embodiment, the apparatus includes four second generation pieces that fit together to form a second layer in the container. In a further embodiment, at least one second generation piece includes identity information of a grandparent. In another embodiment, each grandparent is related to a parent identified on at least one of the first generation pieces through a genealogical relationship. In an additional embodiment, the apparatus includes eight third generation pieces that fit together to form a third layer in the container. In a further embodiment, at least one third generation piece includes identity information of a great grandparent. In another embodiment, each great grandparent is related to a grandparent identified on at least one of the second generation pieces through a genealogical relationship.

In one embodiment, the apparatus includes sixteen fourth generation pieces that fit together to form a fourth layer in the container. In a further embodiment, at least one fourth generation piece includes identity information of a great great grandparent. In an additional embodiment, each great great grandparent is related to a great grandparent identified on at least one of the third generation pieces through a genealogical relationship.

In one embodiment, the pieces in the first layer fit together to substantially occupy the space of the first layer. In a further embodiment, the pieces in the second layer fit together to substantially occupy the space of the second layer. In another embodiment, the pieces in the third layer fit together to substantially occupy the space of the third layer.

An apparatus of the present invention is presented for displaying genealogy information. In one embodiment, the apparatus includes a container. In an additional embodiment, the apparatus includes one or more first generation pieces that fit together to form a first layer in the container. In another embodiment, at least one first generation piece includes a surface for marking identity information of a person. In one embodiment, the first generation pieces are shaped to substantially occupy the available space within the container allocated for the first layer. In a further embodiment, the apparatus includes one or more second generation pieces that fit together to form a second layer in the container. In an additional embodiment, at least one second generation piece includes a surface for marking identity information of a person. In another embodiment, the pieces of the second layer are shaped to substantially occupy the available space within the container allocated for the second layer. In an additional embodiment, the apparatus includes one or more third generation pieces that fit together to form a third layer in the container. In one embodiment, at least one third generation piece includes a surface for marking identity information of a person. In a further embodiment, the pieces of the third layer are shaped to substantially occupy the available space within the container allocated for the third layer. In another embodiment, the first, second and third layers stack within the container on top of each other.

An apparatus of the present invention is presented for displaying genealogy information. In one embodiment, the apparatus includes one or more first generation pieces that fit together to form a first layer. In a further embodiment, at least one first generation piece includes identity information of a person (“first generation person”). In another embodiment, each first generation person is related to a person (“original person”) through a genealogical relationship. In an additional embodiment, the apparatus includes one or more second generation pieces that fit together to form a second layer. In a further embodiment, at least one second generation piece includes identity information of a person (“second generation person”). In another embodiment, each second generation person is related to a first generation person identified on at least one of the first generation pieces through a genealogical relationship. In an additional embodiment, the apparatus includes an alignment mechanism to align the pieces and the first and second layers. In a further embodiment, the first layer and second layer stack on top of each other.

In one embodiment, the apparatus includes one or more additional generation pieces forming one or more additional layers. In another embodiment, at least one additional piece includes identity information of a person. In a further embodiment, each person on an additional piece is related to another person identified on another layer.

In one embodiment, the original person includes a child. In another embodiment, each first generation person includes a parent of the child. In an additional embodiment, each second generation person includes a grandparent of the child.

In one embodiment, the identity information of a person includes a name, a birth date, a christening date, a baptismal date, a marriage date, a death date, and/or a familial relationship status. In another embodiment, each piece includes an identifier that includes information regarding order of the piece within the plurality of pieces. In an additional embodiment, the pieces within a layer include at least one piece with identity information of a person related through a relationship other than a biological relationship.

In one embodiment, the identity information is engraved into a piece. In another embodiment, the identity information is burned into a piece. In an additional embodiment, the identity information is printed on a piece. In a further embodiment, the identity information is attached to a piece with an adhesive.

In one embodiment, the apparatus includes one or more base generation pieces that fit together to form a base layer. In another embodiment, at least one base generation piece includes identity information of the original person. In a further embodiment, each piece in the base layer includes identity information of a person related to a first generation person through a genealogical relationship.

In one embodiment, one or more pieces within a layer fit substantially within a footprint of a piece in an adjacent layer. In another embodiment, identity information of the one or more pieces within the layer is for people genealogically related to the person identified by the identity information on the piece in the adjacent layer.

In one embodiment, the alignment mechanism includes at least one vertical post positioned to be around the edges of the plurality of the pieces, on the corners of the plurality of pieces, and/or extending through the pieces. In another embodiment, the alignment mechanism includes interlocking pieces within a layer and/or interlocking of pieces between layers. In an additional embodiment, the pieces within a layer include shapes other than rectangles and are shaped to fit together in a particular order.

In one embodiment, the pieces within a layer include magnets. In another embodiment, polarity of the magnets align the pieces in a particular order. In a further embodiment, the plurality of pieces, when fit together, include a square shape, a rectangular shape, a cylindrical shape, an organic shape, and/or a round shape.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a perspective view illustrating one embodiment of an apparatus for displaying genealogy information in accordance with the present invention, with identity information included on the container;

FIG. 1B is a top view of the apparatus of FIG. 1A, with the lid removed, exposing the first layer of genealogical pieces;

FIG. 1C is a top view of the apparatus of FIG. 1A, with the first layer of genealogical pieces removed, exposing the second layer of genealogical pieces;

FIG. 1D is a front cutaway view of the apparatus of FIG. 1A;

FIG. 1E is a rear cutaway view of the apparatus of FIG. 1A;

FIG. 1F is a left side cutaway view of the apparatus of FIG. 1A;

FIG. 1G is a right side cutaway view of the apparatus of FIG. 1A;

FIG. 2A is a front cutaway view illustrating an alternate embodiment of an apparatus in accordance with the present invention, which includes four layers;

FIG. 2B is a top view of the apparatus of FIG. 2A, with the first two layers of genealogical pieces removed, exposing the third layer of genealogical pieces;

FIG. 2C is a top view of the apparatus of FIG. 2A, with the first three layers of genealogical pieces removed, exposing the fourth layer of genealogical pieces;

FIG. 3 is a top view illustrating an alternate embodiment of an apparatus in accordance with the present invention, with non-rectangular shaped genealogical pieces that can only fit together in one way;

FIG. 4 is a top view illustrating an alternate embodiment of an apparatus in accordance with the present invention, with genealogical pieces that form puzzle-like shapes;

FIG. 5 is a front cutaway view illustrating an alternate embodiment of an apparatus in accordance with the present invention, with the genealogical pieces having unique top/bottom shapes, so that they only fit together in one way;

FIG. 6A is a perspective view illustrating an alternate embodiment of an apparatus in accordance with the present invention, with no container, and with uniquely shaped genealogical pieces that only fit together in one way;

FIG. 6B is a alternate perspective view of the apparatus of FIG. 6A, with the first layer of genealogical pieces removed, exposing the second layer of genealogical pieces;

FIG. 6C is an alternate embodiment of the apparatus of FIG. 6A, with two additional layers of genealogical pieces, with a stand;

FIG. 7 is a perspective view illustrating an alternate embodiment of an apparatus in accordance with the present invention, with no container, with a stand that includes vertical posts in the corners;

FIG. 8 is a perspective view illustrating an alternate embodiment of an apparatus in accordance with the present invention, with multiple containers, each holding a set of genealogical pieces, which fit together in a super container;

FIG. 9A is a top view illustrating an alternate embodiment of an apparatus in accordance with the present invention, with genealogical pieces that include piece ordering information;

FIG. 9B is a top view of the apparatus of FIG. 9A, with the first layer of genealogical pieces removed, exposing the second layer of genealogical pieces, which include piece ordering information.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

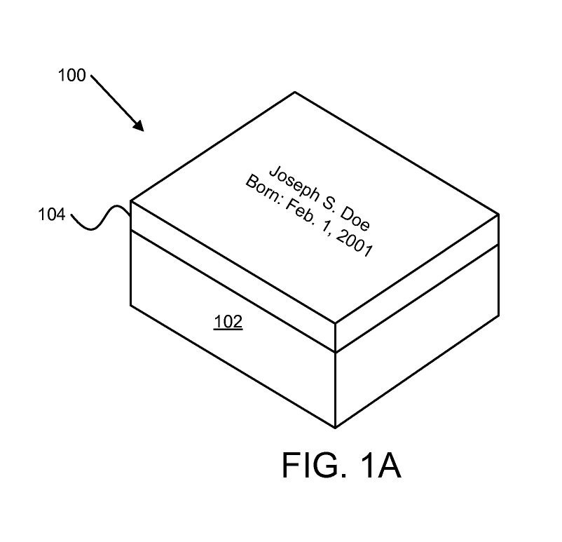

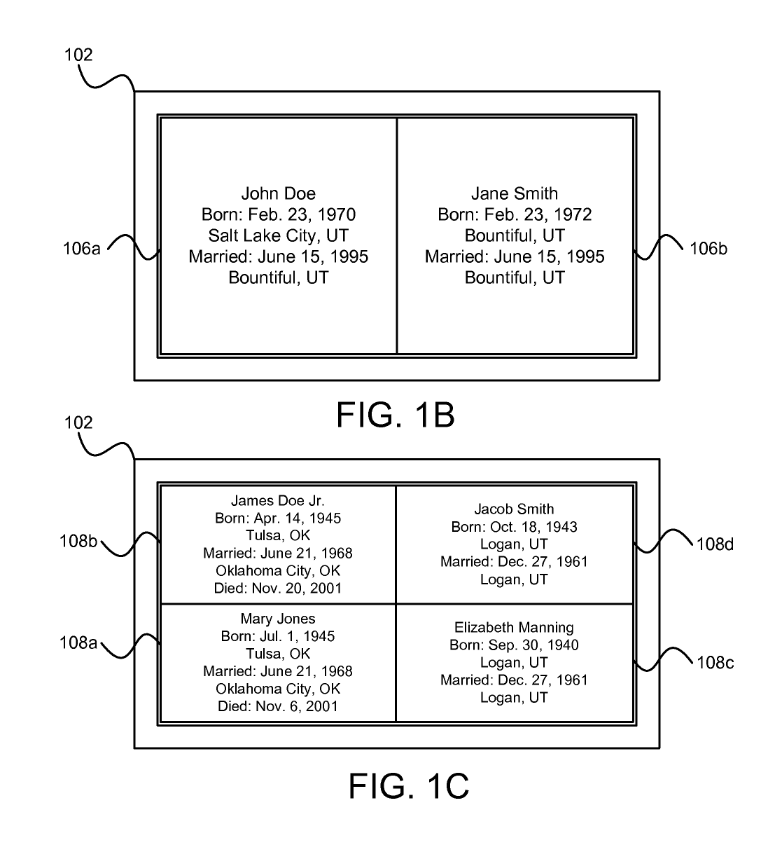

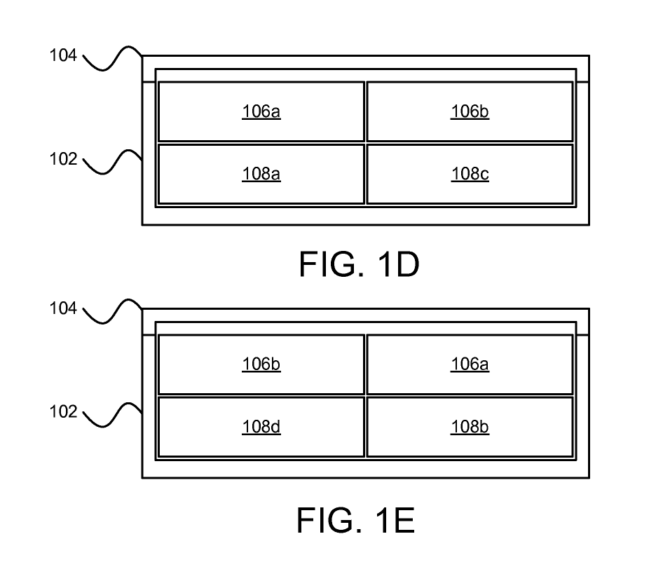

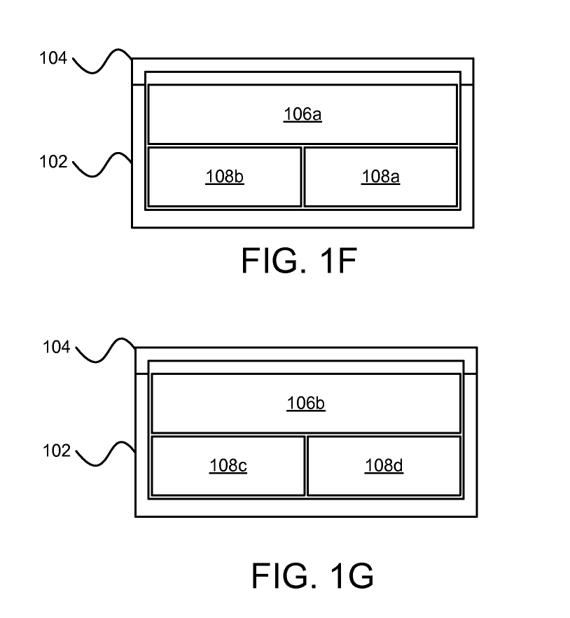

FIGS. 1A, 1B, 1C, 1D, 1E, 1F and 1G (collectively “FIG. 1”) are various views of one embodiment of an apparatus 100 for displaying genealogical information in accordance with the present invention. The embodiment of the apparatus 100 depicted in FIG. 1 includes a container 102, and a lid 104. The container 102 contains first and second generation pieces 106a, 106b (collectively “106”), 108a, 108b, 108c, 108d (collectively “108”). The first generation pieces 106 form a first layer and the second generation pieces form a second layer. Each piece may represent an individual related to the original person, for example in the family tree or pedigree chart of the original person. At least one of the first generation pieces 106 includes identity information of a person (“first generation person”) that is related to the original person through a genealogical relationship. For example, a first generation person may be a parent of the original person and the first generation pieces 106 may include identity information of the parents of the original person. Likewise, at least one of the second generation pieces 108 includes identity information of a person (“second generation person”). Each second generation person is related to a first generation person identified on at least one of the first generation pieces 106 through a genealogical relationship. For example, each second generation person may be a parent of a first generation person and a grandparent of the original person.

FIG. 1A is a schematic perspective view of an embodiment of the apparatus 100 for displaying genealogical information in accordance with the present invention. In the depicted embodiment, the pieces in the first and second layers 106, 108 are enclosed within container 102 and lid 104, and are therefore not shown. Also, in the depicted embodiment, the pieces within a layer fit such that the pieces substantially fill a layer within the container. In various embodiments, the apparatus 100 and its components may be made from various materials or elements, including but not limited to stone, metal, wood, plastic, ceramic, glass, clay, or the like. Additionally, in different embodiments, the apparatus 100 and its components may have a variety of decorative features, including but not limited to bevels, borders, edges, inlay, and the like.

The container 102 may, in alternative embodiments, be a box, cylinder, a sphere, or other alternative means of holding the individual pieces in place. Different embodiments of the container 102 may include various shapes, including round, rectangular, square, or the like. The container 102, in an alternative embodiment, may contain containers inside of containers, much like Russian nesting dolls, where each individual piece or component includes a container or box. The container 102, in one embodiment, is decorative and of high quality. A high quality, durable, and aesthetically pleasing manner of construction may allow the apparatus 100 to function as a display object, as well as an heirloom.

In the apparatus 100 depicted in FIG. 1, the original person is Joseph S. Doe, whose information is on the outside of the cover 104. Also in the apparatus 100, the first generation pieces 106a, 106b represent a couple, John Doe and Jane Smith, who are the parents of the original person, and in the apparatus 100 are situated so as to be displayed when the cover 104 is removed, as shown in FIG. 1B. FIG. 1C depicts the container 102 with the first layer removed exposing the second layer. The second generation pieces on the left 108a, 108b include identity information of parents of John Doe, which are James Doe, Jr. and Mary Jones. Also, the second generation pieces on the right 108c, 108d include identity information of parents of Jane Smith, which are Jacob Smith and Elizabeth Manning. Note that in the embodiment of FIG. 1 the first layer is above the second layer. In other embodiments layers may be in any order, so the second layer may be above the first layer.

In some embodiments, the identity information of a first generation person and a second generation person may include genealogical information, which in various embodiments may include name, date of birth, date of death, date of marriage, place of birth, place of death, place of marriage, place of burial, profession, photographs or other images, decorative design, art, or the like. The information contained on each piece is typically only limited by the space available on each piece. In various embodiments, the identifying information may be engraved into a piece, burned into a piece, printed on a piece, attached to a piece with an adhesive, or the like.

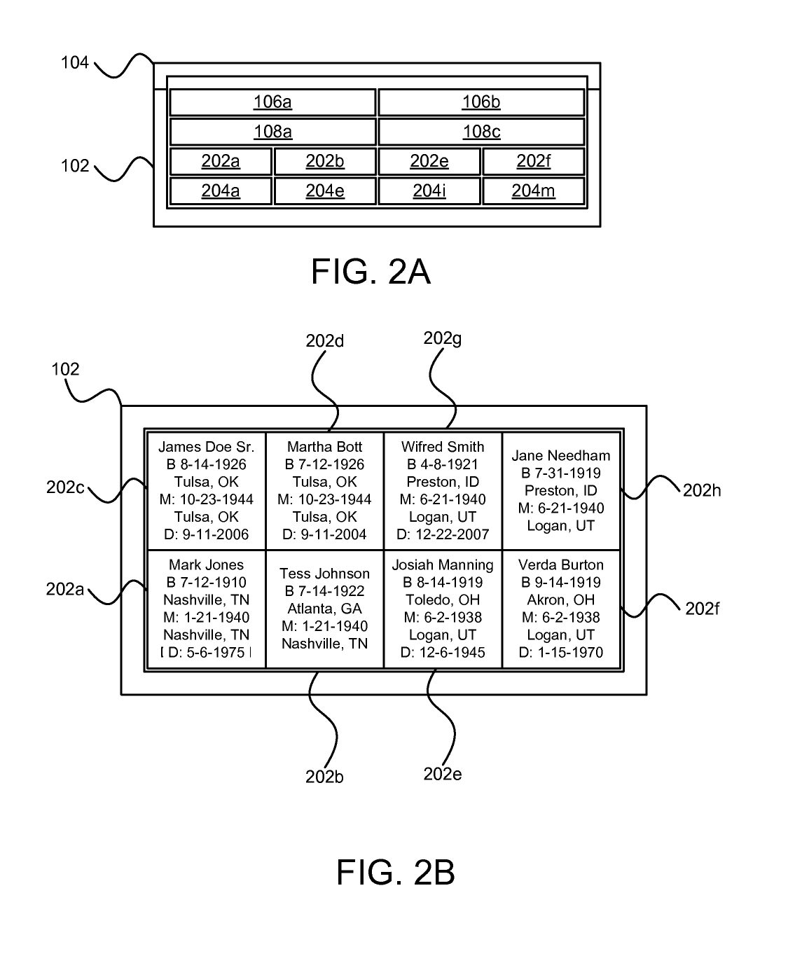

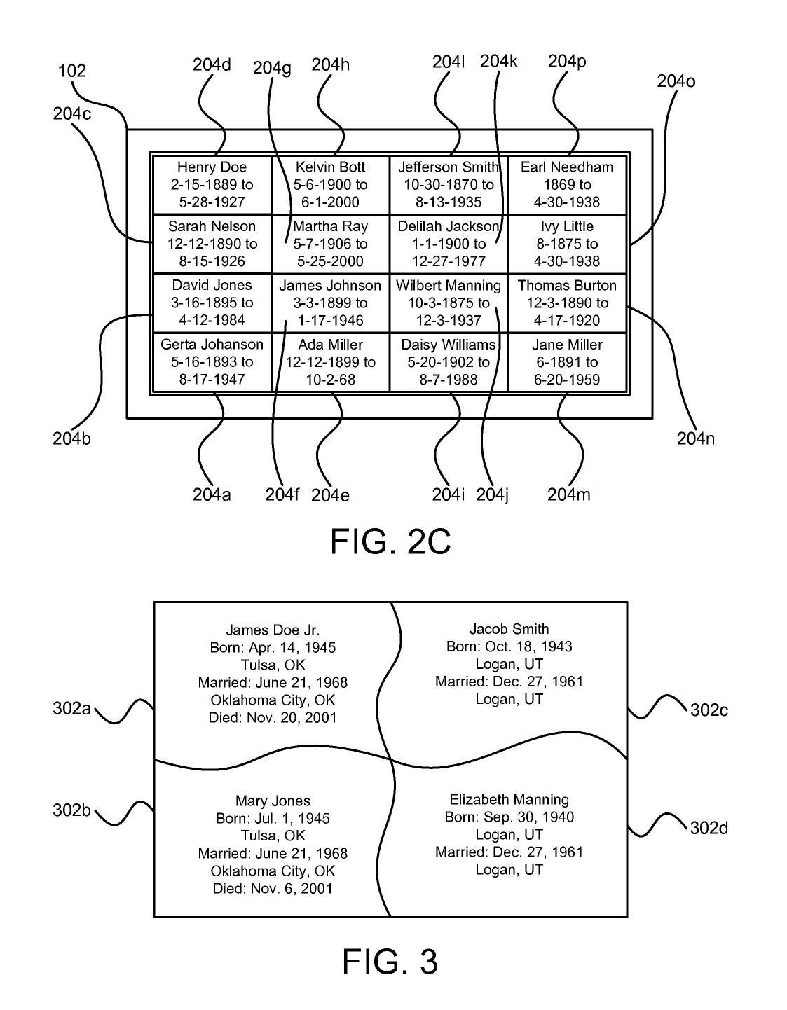

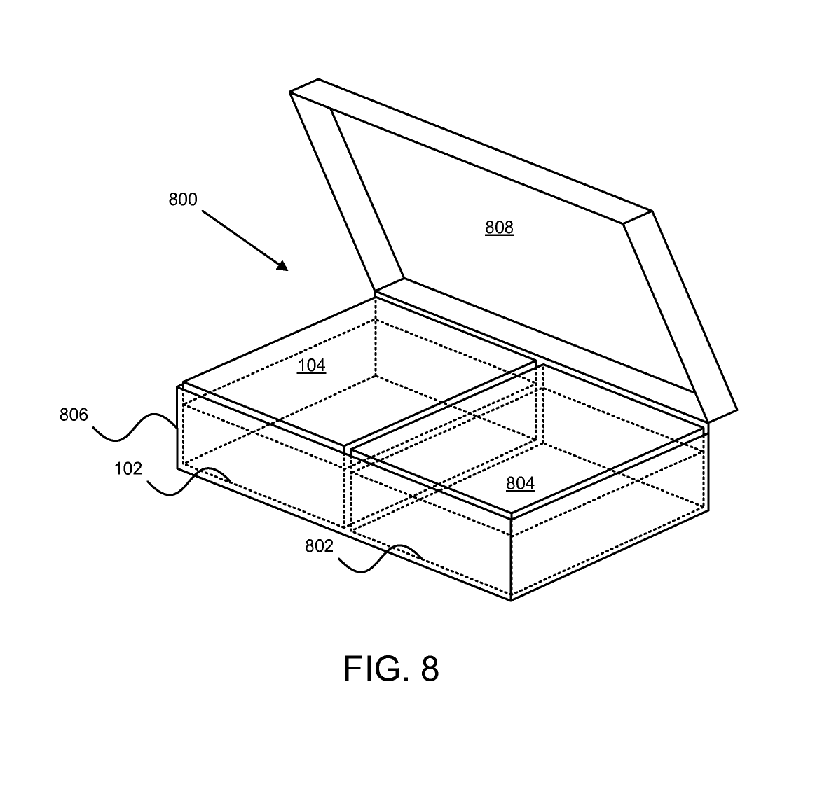

The container 102 could contain two layers, as depicted in FIG. 1B, but is not limited to only two layers. Alternative embodiments could include three, four, or more layers, representing respectively three, four, or more generations, which will be explained further in relation to FIG. 2. Each layer, in one embodiment, has twice as many pieces as the previous layer, creating a 1:2 relationship for each piece. The first layer may start with any number of pieces or components, such as two, four, eight, or a different number, depending on the size of the apparatus 100 and the unique circumstances of the family situation to be represented by the particular embodiment. Additionally, alternative embodiments may include additional configurations of pieces within each layer, for example to include blank pieces, fewer pieces, or additional pieces to accommodate unknown family members, adoptions, additional marriages, and the like. Additionally, multiple containers may be grouped together to expand genealogical collections, which will be explained further in relation to FIG. 8.

FIG. 1D is a front cutaway view and FIG. 1E is a rear cutaway view of an embodiment of the apparatus 100 for displaying genealogical information in accordance with the present invention. The first generation pieces 106a, 106b fit together to form a first layer. In the depicted embodiment, the second generation pieces 108a, 108b, 108c, 108d are situated below the first generation pieces 106, and fit together to form a second layer. Because the first generation pieces 106a, 106b run the length of the container 102, they are visible in FIG. 1E as well. However, because the second generation pieces 108a-d are only the length of half the container, two are only visible from one side cutaway or the other. As seen in FIGS. 1B and 1C, the first generation piece on the left 106a contains identity information for John Doe, and his parents, James Doe Jr. and Mary Jones are the second generation pieces on the left 108a, 108b in FIG. 1C, so the second generation pieces 108a, 108b representing James Doe Jr. and Mary Jones are displayed in FIGS. 1D and 1E below the first generation piece 106a that represents John Doe. Similarly, the second generation pieces 108c, 108d contain the information for the parents of Jane Smith and are displayed in FIGS. 1D and 1E below the first generation piece 106b.

FIG. 1F is a left side cutaway view and FIG. 1G is a right side cutaway view of one embodiment of the invention. FIG. 1F shows that the first generation piece 106a representing John Doe runs the length of the container 102, while the second generation pieces 108b, 108a, are side-by-side and correlate to the relationship of the first and second generation pieces 106, 108 shown in FIGS. 1B and 1C Likewise FIG. 1G shows that the first generation piece 106b representing Jane Smith runs the length of the container 102 and covers the second generation pieces 108c, 108d representing Jane Smith's parents, which are side-by-side as depicted in FIGS. 1B and 1C.

In other embodiments, one or more additional generation pieces forming one or more additional layers may be included. Each additional layer includes at least one additional piece with identity information of a person, and each person on an additional piece is related to another person identified on another layer. FIGS. 2A, 2B, and 2C (collectively “FIG. 2”) depict a particular embodiment of the embodiment depicted in FIG. 1 with two additional generation pieces forming two additional layers.

In the embodiment depicted in FIG. 2, the container 102 contains four layers of pieces with genealogical data, with each layer representing one generation. FIG. 2A is a front cutaway view showing four layers. FIG. 2B depicts the container 102 with the first two layers removed, exposing the third layer. In the embodiment, there are eight third generation pieces 202a-h (collectively “202”), which fit together to form a complete layer. Each of the third generation pieces 202, in the depicted embodiment, includes identity information of an individual related through a genealogical relationship to the individuals whose information is contained on pieces in the second layer. In the depicted embodiment, the third generation pieces include identity information of the great grandparents of the original person, Joseph S. Doe, whose identity information is included on the container 102, and of the parents of people identified on the second generation pieces 108.

In the embodiment, the third generation pieces on the top left 202c, 202d represent a couple, James Doe Sr. and Martha Bott, who are the parents of James Doe Jr and fit in the footprint of the second generation piece 108b representing James Doe Jr. Also in the embodiment, the third generation pieces on the bottom left 202a, 202b represent a couple, Mark Jones and Tess Johnson, who are the parents of Mary Jones and fit in the footprint of the second generation piece 108a representing Mary Jones. Additionally, the third generation pieces on the top right 202g, 202h represent a couple, Wilfred Smith and Jane Needham, who are the parents of Jacob Smith, and fit in the footprint of the second generation piece 108d representing Jacob Smith, and the third generation pieces on the bottom right 202e, 202f represent a couple, Josiah Manning and Verda Burton, who are the parents of Elizabeth Manning, and fit in the footprint of the second generation piece 108c representing Elizabeth Manning (again see FIG. 1C).

FIG. 2C depicts the container 102 with the first three layers removed, exposing the fourth layer. In one embodiment, the fourth layer contains sixteen fourth generation pieces 204a-p (collectively “204”), each of which contain the identity information of individuals related through a genealogical relationship to the individuals whose information is contained on pieces in the third layer. In the embodiment depicted in FIG. 2, the fourth generation pieces provide the identity information for the great great grandparents of the original person and the parents of the people represented by the third generation pieces 202a-h. In one embodiment, each of the pieces in the fourth genealogical layer is physically smaller than the pieces 106, 108, 202 of the first three layers, so less genealogical information is contained on each piece. The fourth generation pieces 204 in the embodiment depicted in FIG. 2 contain only a name, birth date and death date. The fourth generation pieces 204 are arranged so that two fourth generation pieces 204 fit in the footprint of a third generation piece 202 and include identity information for the parents of the third generation piece above (e.g. 202a, 204a, 204b). As with FIG. 1, alternate embodiments of FIG. 2 may include layers in an order other than the order displayed in FIG. 2A.

In other embodiments, the generation pieces within a layer (e.g. 104, 106, 202, 204) may be shaped to fit in a particular order or may interlock. FIG. 3 depicts an alternative embodiment of the second layer depicted in FIG. 1C wherein the pieces are shaped to fit together in a particular order. In the depicted embodiment, each of the generation pieces 302a-d in a layer has a unique shape, so that the generation pieces 302a-d will only fit together in one configuration. In different embodiments of the invention, individual pieces or components may be uniquely shaped so as to only fit together one way, contain connectors, magnets, or the like that allow individual pieces to fit, connect, fasten or hold together. In this way, if the genealogical pieces are removed from the container 102, platform, or other display apparatus, they can easily be returned to the proper configuration, with the appropriate relationships between each individual being properly represented. In the alternate embodiments, the genealogical pieces can be easily removed, examined, played with, and returned without worry about which piece belongs in where. Families or individuals can then use the invention to graphically display, learn about, and easily remember the relationships which form their individual family history.

In another embodiment, (not shown) generation pieces that represent parents of an individual may have a unique shape along an edge common to the generation pieces that represent the parents but may have straight edges on other sides. For example, the first generation pieces of James Doe Jr. and Mary Jones 108a, 108b may have a curved edge where these second generation pieces 108a, 108b meet, but the other sides may have straight edges as shown in FIG. 1C. The generation pieces (e.g. 108a, 108b) may match some unique shape of the child piece (e.g. the first generation piece of John Doe 106a) or may not share some unique edge of the child piece and may not exactly fit in the footprint of the child piece. One of skill in the art will recognize other ways that generation pieces may be shaped to uniquely fit together.

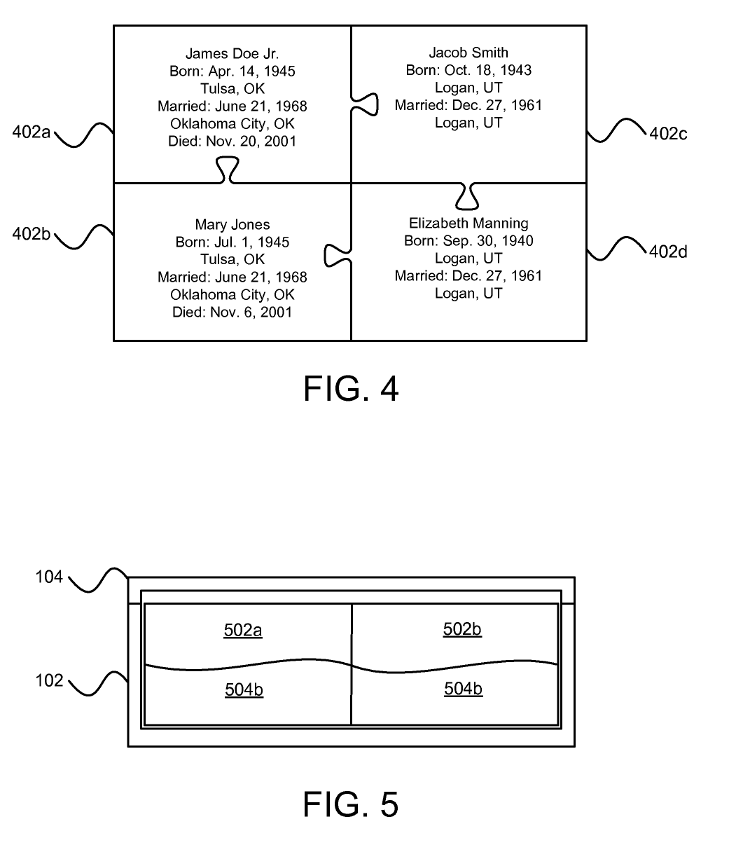

FIG. 4 shows an alternative embodiment in which the pieces 402a-d each have a unique pattern, allowing them to be fit together in only one configuration. In the embodiment depicted in FIG. 4, the pieces within a layer interlock. In another embodiment, the interlocking mechanism depicted in FIG. 4 may be combined with the shape variations depicted in FIG. 3. In other embodiments, the interlocking and alternative shapes may be combined in any manner to provide a layer. The embodiments described in relation to FIGS. 3 and 4 may be used to create a unique puzzle-like apparatus that may entertain as well as teach or display genealogical information.

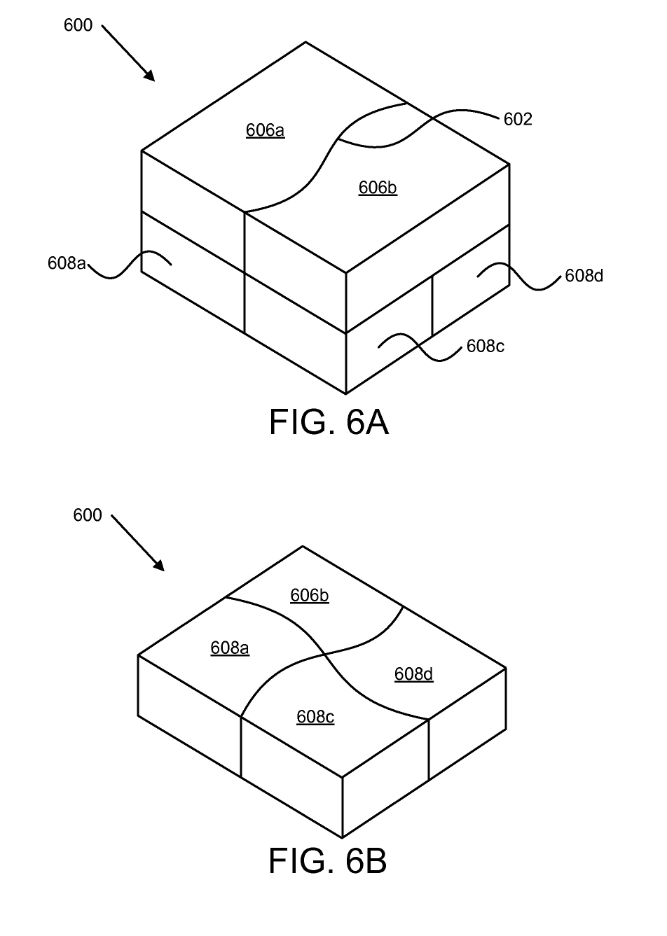

FIG. 5 depicts an alternative embodiment of the invention in which the top and bottom surfaces of the pieces 502, 504 have a unique shape, allowing them to be fit together and placed in the container 102 in only one configuration. In the embodiment depicted in FIG. 5, the pieces within a layer include shapes other than rectangles, and are shaped to fit together in a particular order. In other embodiments, the interlocking and alternative shapes may be combined together with the shape variations depicted in FIGS. 3 and 4 to provide a layer. The pieces, in various embodiments, may interlock within a layer, interlock between layers, interlock within a layer and between layers, not interlock at all, etc.

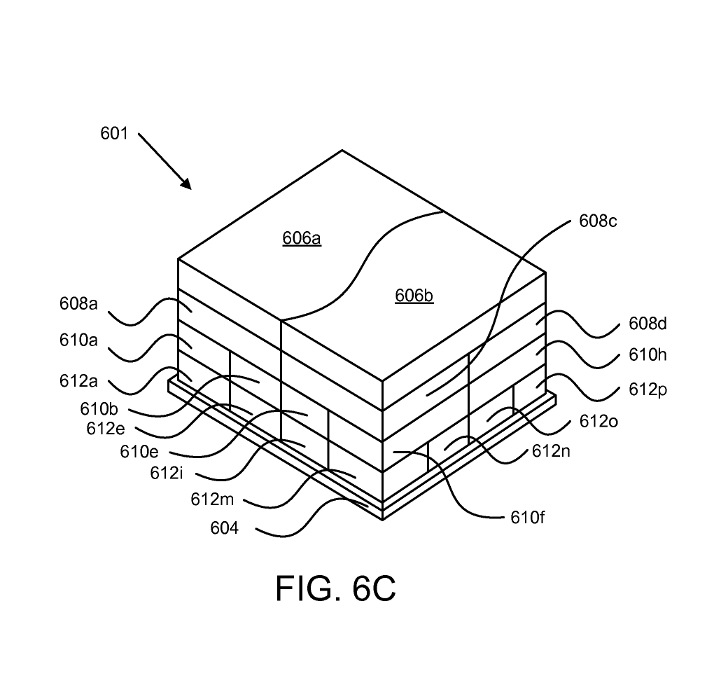

FIGS. 6A and 6B depict one embodiment of an apparatus 600 for displaying genealogical information in accordance with the present invention which includes an alignment mechanism. The apparatus 600 includes first generation pieces 606a, 606b (collectively “606”), and second generation pieces 608a, 608b, 608c, 608d (collectively “608”). The alignment mechanism of the apparatus, in the embodiment depicted in FIG. 6, includes of each of the first generation pieces 606 and second generation pieces 608 forming a unique shape such that the pieces can only fit together in one way. Where the first generation pieces 606 fit together, the side of each of the pieces forms a complementary curve 602. FIG. 6B depicts the apparatus with the first layer removed, exposing the second layer. The second generation pieces have complementing curved sides, similar to the first generation pieces, such that the second generation pieces 608 can fit together in only one way.

The first generation pieces 606 form a first layer, and the second generation pieces 608 form a second layer. Each piece may represent an individual related to the original person, for example, in the family tree or pedigree chart of the original person. At least one of the first generation pieces 606 includes identity information of a person (“first generation person”) that is related to the original person through a genealogical relationship. For example, a first generation person may be a parent of the original person and the first generation pieces 606 may include identity information of the parents of the original person. Likewise, at least one of the second generation pieces 608 includes identity information of a person (“second generation person”). Each second generation person is related to a first generation person identified on at least one of the first generation pieces 606 through a genealogical relationship. For example, each second generation person may be a parent of a first generation person and a grandparent of the original person. The apparatus 600 may be desired because it may display the first and second layers without the layers being hidden in a container 102. In other embodiments, the alignment mechanism may include interlocking pieces, like a puzzle, magnets, posts with holes through the pieces, etc. The curved pieces depicted in FIGS. 6A and 6B, in other embodiments, may be combined with other alignment mechanisms. One of skill in the art will recognize other alignment mechanisms and combinations.

FIG. 6C depicts another embodiment of an apparatus 601 for displaying genealogical information in accordance with the present invention which includes an alignment mechanism. The apparatus 601 depicted in FIG. 6C shows an additional embodiment of the apparatus 600 depicted in FIGS. 6A and 6B. The apparatus 601 in FIG. 6C includes two additional layers. The top two layers, in the depicted embodiment, include a first layer with first generation pieces 606 and a second layer with second generation pieces 608 with are substantially similar to those described above in relation to the apparatus 600 depicted in FIGS. 6A and 6B. The apparatus 601 includes a third layer that contains third generation pieces 610. The third generation pieces 610 include identity information for at least one individual related to a second generation person. (Each individual represented by identity information on the third generation pieces 610 may be called a third generation person.)

The apparatus 601 also includes a fourth layer with fourth generation pieces 612 with identity information for at least one individual related to a third generation person. (Each individual represented by identity information on the fourth generation pieces 612 may be called a fourth generation person.) In the depicted embodiment, the combined generation pieces 606, 608, 610, 612 fit together, and rest on a stand 604. The generation pieces 606, 608, 610, 612 in the depicted embodiment fit together in only one way due to the unique shape of each of the generation pieces 606, 608, 610, 612.

In another embodiment, the generation pieces 606, 608, 610, 612 could include magnets, and the polarity of the magnets align the generation pieces 606, 608, 610, 612 in a particular order. The generation pieces 606, 608, 610, 612, in various additional embodiments, could include magnets, form unique shapes, interlock, form puzzle-like shapes, contain a removable adhesive, include suction cups, or fit together in various other ways. In different embodiments, the plurality of generation pieces 606, 608, 610, 612, when fit together, could form a square shape, a rectangular shape, a cylindrical shape, an organic shape, a round shape, a spherical shape, or some other shape.

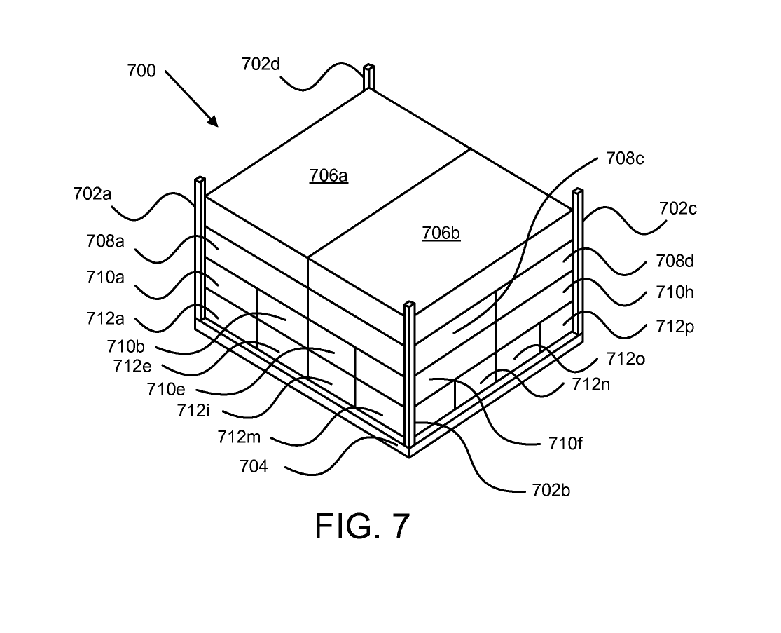

In other embodiments, the alignment mechanism may include one or more one vertical posts positioned around the edges of the plurality of generation pieces, on the corners, and/or extending through the generation pieces. FIG. 7 depicts one embodiment of an apparatus 700 with vertical posts 702a-d on four corners of a base 704. The apparatus 700 includes first, second, third, and fourth generation pieces 706a-b, 708a-d, 710a-h, 712a-p that fit together, and are held in place by the vertical posts 702a-d.

Other embodiments may include multiple posts around the edges as well as the corners, posts only around the edges, posts through the generation pieces 706, 708, 710, 712, a combination of posts through one or more of the corners, the edges, and through the generation pieces 706, 708, 710, 712, and the like. There could, in some embodiments, be posts only on a single side, on two sides, on three sides, or on four sides. Various embodiments may include posts that are taller than the height of the plurality of layers, posts that are shorter than the height of the layers, or posts that are the same height as the layers.

Some embodiments may include removable posts. In other embodiments, posts may wrap around the top of the generation pieces 706, 708, 710, 712. In some embodiments, posts may connect to more than one side, forming an arch, a square, a cage-like formation, or the like. The corners in the embodiment depicted in FIG. 7 have a square shape, but in other embodiments, the posts could form triangular shapes, cylindrical shapes, squiggly shapes, organic shapes, or some other shape.

FIG. 8 depicts one embodiment of the invention, where the apparatus 800 includes a container 102 (first container 102) associated with an original person, and further includes a second container 802 and a super container 806. The second container 802 may include pieces related to a spouse or a partner of the original person. In the apparatus 800, the first and second containers 102, 802 fit within the super container 806. The super container 806 may include identity information of a child of the original person and/or the person associated with the second container 802. The first and second containers 102, 802 could be shape and size, as depicted in FIG. 8, or could be of different shapes and/or sizes. There could be more than two or less than two containers that fit inside the super container 806. In some embodiments, there could be two or more sets of genealogical pieces that fit together without a container 102, 802 that all fit within one super container 806. In the apparatus 800 depicted in FIG. 8, the first and second containers 102, 802 include lids 104, 804, and the super container 806 includes a lid 808. In additional embodiments, the containers 102, 802 could have removable lids, hinged lids, other types of covering, or no lid or covering. In various embodiments, the different containers could each be made of the same material or different materials.

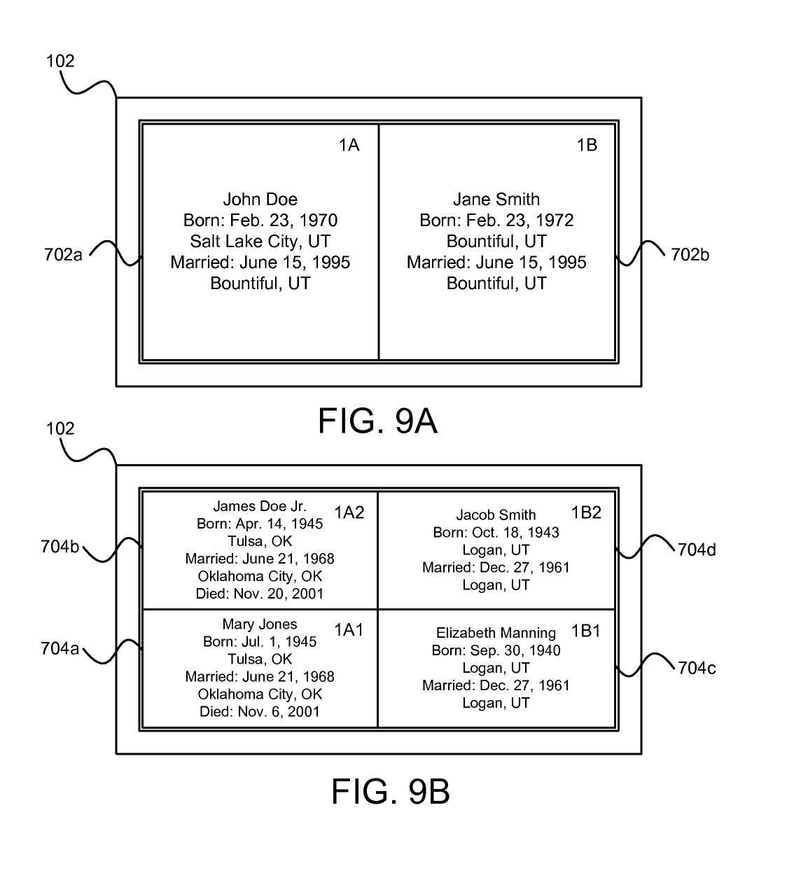

FIG. 9 depicts one embodiment of the present invention, where the first and second generation pieces 702, 704 fit together to form a first and a second layer within the container 102. In the embodiment depicted in FIG. 9, each generation piece 702a-b, 704a-d may include identity information of a person. The identity information could include any or all of a name, a birth date, a christening date, a baptismal date, a marriage date, a death date, a familial relationship status, or another piece of identity information.

In one embodiment, as shown in FIG. 9, each generation piece 702a-b, 704a-d may also include an identifier. The identifier includes information regarding order of the generation pieces 702, 704 within a container 102. The generation piece ordering information in the depicted embodiment follows the pattern “1A”-“1A1”-“1A1A,” etc., for the various individuals with genealogical relationships across generations. The first layer includes identifiers 1A for the first generation piece 702a associated with John Doe and 1B for the first generation piece 702b associated with Jane Smith.

Each second generation piece 704a, 704b associated with John Doe includes a derivation of identifier 1A so that the second generation piece 704a includes 1A1 and the second generation piece 704b includes 1A2. Similarly the second generation pieces 704c, 704d associated with Jane Smith include identifiers 1B1 and 1B2 respectively. Third generation pieces (not shown) in a third layer may then each include an additional letter. For example, the second generation piece 704a with identifier 1A1 may include be associated with third generation pieces with identifiers 1A1A and 1A1B. The pattern may be repeated for other third or fourth generation pieces. A layer associated with an original person may include identifier 1.

In other embodiments, the piece ordering information could follow other different patterns. The piece ordering information could include colors, letters, numbers, symbols, designs, patterns, or the like. In various embodiments, some of the genealogical pieces may not include piece ordering information. In FIG. 9 the piece ordering information is in the top right of each generation pieces 702, 704, but in various other embodiments the ordering information could be located elsewhere on the generation pieces 702, 704, such as on the face, on the back, on the top, on the bottom, or on a side. In different embodiments, the identity information and the piece ordering information could be engraved into a generation piece, burned into a generation piece, printed on a generation piece, attached on a generation piece with an adhesive, or otherwise integrated into the generation piece.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a container;
one or more first generation pieces that fit together to form a first layer in the container, at least one first generation piece comprising identity information of a person (“first generation person”), each first generation person related to a person (“original person”) through a genealogical relationship; and
one or more second generation pieces that fit together to form a second layer in the container, at least one second generation piece comprising identity information of a person (“second generation person”), each second generation person related to a first generation person identified on at least one of the first generation pieces through a genealogical relationship.

2. The apparatus of claim 1, further comprising one or more additional generation pieces forming one or more additional layers, at least one additional piece comprising identity information of a person, each person on an additional piece related to another person identified on another layer.

3. The apparatus of claim 1, wherein the original person comprises a child, each first generation person comprises a parent of the child, and each second generation person comprises a grandparent of the child.

4. The apparatus of claim 3, further comprising one or more third generation pieces that fit together to form a third layer in the container, at least one third generation piece comprising identity information of a great grandparent of the child.

5. The apparatus of claim 1, wherein the pieces within a layer fit such that the pieces substantially fill a layer within the container.

6. The apparatus of claim 1, wherein the pieces within a layer interlock.

7. The apparatus of claim 1, wherein the container comprises a box and each layer comprises pieces that fit together to form a layer and to substantially fill a space comprising the layer.

8. The apparatus of claim 1, wherein the pieces within a layer comprise shapes other than rectangles and are shaped to fit together in a particular order.

9. The apparatus of claim 1, wherein the identity information of a person comprises one or more of a name, a birth date, a christening date, a baptismal date, a marriage date, a death date, and a familial relationship status.

10. The apparatus of claim 1, wherein each piece comprises an identifier, the identifier comprising information regarding order of the piece within the container.

11. The apparatus of claim 1, wherein the container comprises one or more of a square shape, a rectangular shape, a cylindrical shape, an organic shape, and a round shape.

12. The apparatus of claim 1, wherein the pieces within a layer comprise at least one piece with identity information of a person related through a relationship other than a biological relationship.

13. The apparatus of claim 1, wherein the container comprises a lid.

14. The apparatus of claim 1, wherein the container comprises information on the exterior of the case relating to the original person.

15. The apparatus of claim 1, wherein the identity information is one of engraved into a piece, burned into a piece, printed on a piece, and attached to a piece with an adhesive.

16. The apparatus of claim 1, further comprising one or more base generation pieces that fit together to form a base layer in the container, at least one base generation piece comprising identity information of the original person, each piece in the base layer comprising identity information of a person related to a first generation person through a genealogical relationship.

17. The apparatus of claim 1, wherein the container is a first container and further comprising a second container and a super container, the second container comprising pieces related to a spouse or a partner of the original person, the first and second containers fitting within the super container.

18. The apparatus of claim 1, wherein one or more pieces within a layer fit substantially within a footprint of a piece in an adjacent layer, wherein identity information of the one or more pieces within the layer is for people genealogically related to the person identified by the identity information on the piece in the adjacent layer.

19. An apparatus comprising:
a container;
two first generation pieces that fit together to form a first layer in the container, at least one first generation piece comprising identity information of a parent, each parent related to a child;
four second generation pieces that fit together to form a second layer in the container, at least one second generation piece comprising identity information of a grandparent, each grandparent related to a parent identified on at least one of the first generation pieces through a genealogical relationship; and
eight third generation pieces that fit together to form a third layer in the container, at least one third generation piece comprising identity information of a great grandparent, each great grandparent related to a grandparent identified on at least one of the second generation pieces through a genealogical relationship.

20. The apparatus of claim 19, further comprising sixteen fourth generation pieces that fit together to form a fourth layer in the container, at least one fourth generation piece comprising identity information of a great great grandparent, each great great grandparent related to a great grandparent identified on at least one of the third generation pieces through a genealogical relationship.

21. The apparatus of claim 19, wherein the pieces in the first layer fit together to substantially occupy the space of the first layer, wherein the pieces in the second layer fit together to substantially occupy the space of the second layer, and wherein the pieces in the third layer fit together to substantially occupy the space of the third layer.

22. An apparatus comprising:
a container;
one or more first generation pieces that fit together to form a first layer in the container, at least one first generation piece comprising a surface for marking identity information of a person, the first generation pieces shaped to substantially occupy the available space within the container allocated for the first layer;
one or more second generation pieces that fit together to form a second layer in the container, at least one second generation piece comprising a surface for marking identity information of a person, the pieces of the second layer shaped to substantially occupy the available space within the container allocated for the second layer; and
one or more third generation pieces that fit together to form a third layer in the container, at least one third generation piece comprising a surface for marking identity information of a person, the pieces of the third layer shaped to substantially occupy the available space within the container allocated for the third layer,
wherein the first layer, the second layer, and the third layer stack within the container on top of each other.

23. An apparatus comprising:
one or more first generation pieces that fit together to form a first layer, at least one first generation piece comprising identity information of a person (“first generation person”), each first generation person related to a person (“original person”) through a genealogical relationship;
one or more second generation pieces that fit together to form a second layer, at least one second generation piece comprising identity information of a person (“second generation person”), each second generation person related to a first generation person identified on at least one of the first generation pieces through a genealogical relationship; and
an alignment mechanism to align the pieces and the first and second layers, wherein the first layer and second layer stack on top of each other.

24. The apparatus of claim 23, further comprising one or more additional generation pieces forming one or more additional layers, at least one additional piece comprising identity information of a person, each person on an additional piece related to another person identified on another layer.

25. The apparatus of claim 23, wherein the original person comprises a child, each first generation person comprises a parent of the child, and each second generation person comprises a grandparent of the child.

26. The apparatus of claim 23, wherein the identity information of a person comprises one or more of a name, a birth date, a christening date, a baptismal date, a marriage date, a death date, and a familial relationship status.

27. The apparatus of claim 23, wherein each piece comprises an identifier, the identifier comprising information regarding order of the piece within the plurality of pieces.

28. The apparatus of claim 23, wherein the pieces within a layer comprise at least one piece with identity information of a person related through a relationship other than a biological relationship.

29. The apparatus of claim 23, wherein the identity information is one of engraved into a piece, burned into a piece, printed on a piece, and attached to a piece with an adhesive.

30. The apparatus of claim 23, further comprising one or more base generation pieces that fit together to form a base layer, at least one base generation piece comprising identity information of the original person, each piece in the base layer comprising identity information of a person related to a first generation person through a genealogical relationship.

31. The apparatus of claim 23, wherein one or more pieces within a layer fit substantially within a footprint of a piece in an adjacent layer, wherein identity information of the one or more pieces within the layer is for people genealogically related to the person identified by the identity information on the piece in the adjacent layer.

32. The apparatus of claim 23, wherein the alignment mechanism comprises at least one vertical post positioned to be one or more of
around the edges of the plurality of pieces;
on the corners of the plurality of pieces; and
extending through the pieces.

33. The apparatus of claim 23, wherein the alignment mechanism comprises one or more of
interlocking of the pieces within a layer; and
interlocking of pieces between layers.

34. The apparatus of claim 23, wherein the pieces within a layer comprise shapes other than rectangles and are shaped to fit together in a particular order.

35. The apparatus of claim 23, wherein the pieces within a layer comprise magnets, wherein polarity of the magnets align the pieces in a particular order.

36. The apparatus of claim 23, wherein the plurality of pieces, when fit together, comprises one or more of a square shape, a rectangular shape, a cylindrical shape, an organic shape, and a round shape.
